(19) United States
(12) Patent Application Publication
(10) Pub. No.: US 2006/0166132 A1
(43) Pub. Date: Jul. 27, 2006

(54) Ultraviolet light transparent nanoparticles for photoresists

(76) Inventor: Robert P. Meagley, Emeryville, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/045,197

(22) Filed: Jan. 27, 2005

(51) Int. Cl. G03C 1/76

(52) U.S. Cl. 430/270.1

(57) ABSTRACT

The transparency of photoresist films to ultraviolet light may be increased without sacrificing photospeed or resolution of the photoresist by including ultraviolet light transparent nanoparticles to the photoresist formulations. The ultraviolet light transparent nanoparticles may be included in the photoresist formulations as filler to “dilute” the ultraviolet light opacity of the photoresist, as side-chains to the photoimageable species that form the photoresist matrix, or as the photoimageable species themselves that form the backbone of the photoresist matrix. The photoresist formulation may also be a hybrid solution of any of these variations on the inclusion of the ultraviolet light transparent nanoparticles. The ultraviolet light transparent nanoparticles may mostly contain carbon or silicon.

### BACKGROUND OF THE INVENTION

1. Field of the Invention

The present invention relates to the field of photolithography to form integrated circuits and more particularly to the field of photoresists used in photolithography.

2. Discussion of Related Art

Photolithography is used in the field of integrated circuit processing to form the patterns that will make up the features of an integrated circuit. A photoresist is employed as a sacrificial layer to transfer a pattern to the underlying substrate. This pattern may be used as a template for etching or implanting the substrate. Patterns are typically created in the photoresist by exposing the photoresist to radiation through a mask. The radiation may be ultraviolet light, extreme ultraviolet (EUV) light, or an electron beam. In the case of a “direct write” electron beam, a mask is not necessary because the features may be drawn directly into the photoresist. Most photolithography is done using either the “i-line” method or the chemical amplication (CA) method. In the i-line method the “i-line” photoresist becomes directly soluble when irradiated and may be removed by a developer. In the chemical amplification method the radiation applied to the photoresist causes the decomposition of a photo-acid generator (PAG) that causes the generation of a small amount of acid throughout the resist. The acid in turn causes a cascade of chemical reactions either instantly or in a post-exposure bake that increase the solubility of the resist such that the resist may be removed by a developer. This is accomplished by including a “solubility switch”, a moiety that is intrinsically unstable to acid, that upon treatment with acid is transformed from insoluble to soluble in developer solution. This cascade of reactions is modulated through the deliberate inclusion of a catalyst poison (a base such as an amine compound) termed a quencher. An advantage of using the CA method is that the chemical reactions are catalytic and therefore the acid is regenerated afterwards and may be reused, thereby decreasing the amount of radiation required for the reactions making it possible to use shorter wavelengths of light such as EUV. The photoresist may be positive tone or negative tone. In a positive tone photoresist the area exposed to the radiation will define the area where the photoresist will be removed. In a negative tone photoresist the area that is not exposed to the radiation will define the area where the photoresist will be removed. The CA method may be used with either a positive tone photoresist or a negative tone photoresist.

To pattern smaller dimensions in photoresists as devices are scaled down, the use of light having smaller wavelengths is being used to achieve these smaller dimensions. Light having wavelengths in the ultraviolet regions or electrons can be used to cause the decomposition of the photo-acid generator in chemically amplified photoresists to pattern these smaller dimensions into a photoresist. But, light having a wavelength in the extreme ultraviolet region is also absorbed by atoms in compounds within the photoresist matrix, such as fluorine and oxygen, and, to a lesser extent, nitrogen and sulfur. The photoresist matrix typically includes large amounts of compounds containing these atoms and therefore much of the light is absorbed. The ultraviolet light is therefore often absorbed completely by the photoresist before the light can reach the lower portions of the photoresist if the photoresist film is too thick. This results in uneven patterning of the photoresist, where the portions of the photoresist that are nearer to the top are over-exposed and the portions of the photoresist near the bottom are incompletely exposed.

The uneven exposure through the entire thickness of the photoresist has led to several changes in the photoresist formulation. Boron has been incorporated into photoresists as covalently bound side-chains to increase the transparency of photoresists irradiated by ultraviolet light because boron is transparent to ultraviolet light. But, the boron from the photoresists may poison the underlying semiconductor based devices because boron is a dopant. Another change in the photoresist formulation was to minimize the amount of oxygen and other ultraviolet absorbing elements. The reduction of oxygen, in particular, led to the significant decrease in photospeed and resolution of the photoresist because oxygen is a main element used as the chemical switches in the polymers that undergo the chain of reactions and change in solubility to developer as a function of exposure. Additionally, the reduction of the amount of oxygen in photoresists increases the hydrophobic properties of the photoresist that may lead to adhesion and wetting problems, and ultimately increased defectivity due to these problems. Another change to photoresists to deal with the uneven absorption of ultraviolet light by the photoresist was to include additives in the photoresist formulation that would form a skin on top of the photoresist to reduce the effects of over exposure at the top surface of the photoresist. But, the formation of the skin to reduce the impact of the photoresist's absorption of the ultraviolet light also reduces photospeed and resolution of the photoresist.

### BRIEF DESCRIPTION OF THE DRAWINGS

FIGS. 1a-1i illustrate cross-sectional views of a process of forming vias employing a photoresist according to an embodiment of the current invention.

FIGS. 2a-2h illustrate examples of different embodiments of ultraviolet light transparent nanoparticles.

### DETAILED DESCRIPTION OF THE PRESENT INVENTION

Described herein are photoresist formulations including ultraviolet light transparent nanoparticles and methods of using the photoresists. In the following description numerous specific details are set forth. One of ordinary skill in the art, however, will appreciate that these specific details are not necessary to practice embodiments of the invention. While certain exemplary embodiments of the invention are described and shown in the accompanying drawings, it is to be understood that such embodiments are merely illustrative and not restrictive of the current invention, and that this invention is not restricted to the specific constructions and arrangements shown and described because modifications may occur to those ordinarily skilled in the art. In other instances, well known semiconductor fabrication processes, techniques, materials, equipment, etc., have not been set forth in particular detail in order to not unnecessarily obscure embodiments of the present invention.

The transparency of photoresist films to ultraviolet light may be increased without sacrificing photospeed or resolution of the photoresist by including ultraviolet light transparent nanoparticles to the photoresist formulations. Ultraviolet light transparent nanoparticles are nanoparticles that are transparent to ultraviolet light. The ultraviolet light transparent nanoparticles may be included in the photoresist formulations as filler to “dilute” the ultraviolet light opacity of the photoresist, as side-chains to the photoimageable species that form the photoresist matrix, or as the photoimageable species themselves that form the backbone of the photoresist matrix. The photoresist formulation may also be a hybrid solution of any of these variations on the inclusion of the ultraviolet light transparent nanoparticles. The ultraviolet light transparent nanoparticles may mostly contain carbon or silicon.

Photoresists containing ultraviolet light transparent nanoparticles may be used to create patterns for the formation of many structures used in integrated circuits. In one embodiment, a chemically amplified photoresist including ultraviolet light transparent nanoparticles may be used to form lines for transistor gates. In another embodiment, a chemically amplified photoresist including ultraviolet light transparent nanoparticles may be used to form trenches or vias for interconnect lines. In one embodiment the chemically amplified photoresists including ultraviolet light transparent nanoparticles may be used to form both vias and trenches by a conventional dual damascene method. Other applications for forming microelectromechanical machines (MEMS), microfluidics structures, or other small structures are also comprehended. For the sake of simplicity a process of forming only vias will be described.

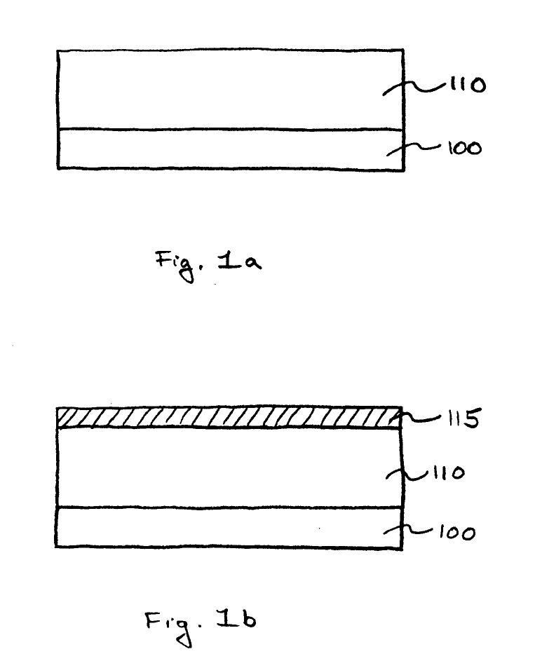

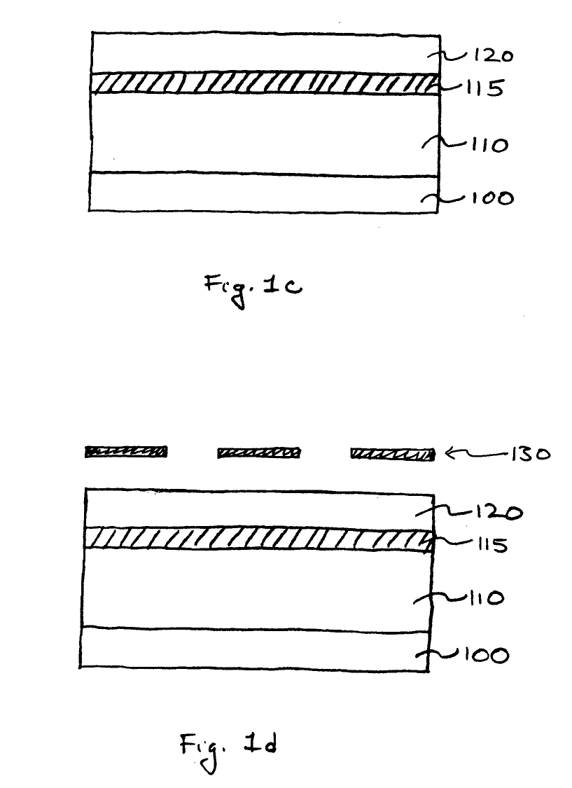

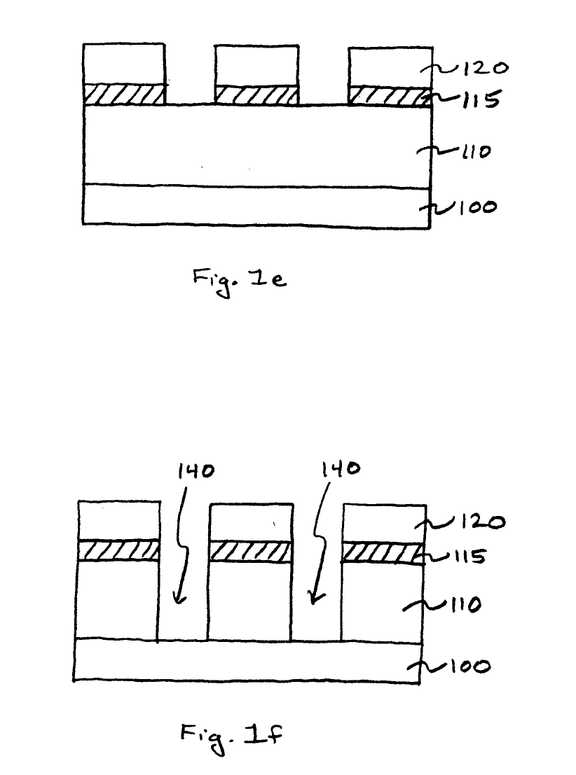

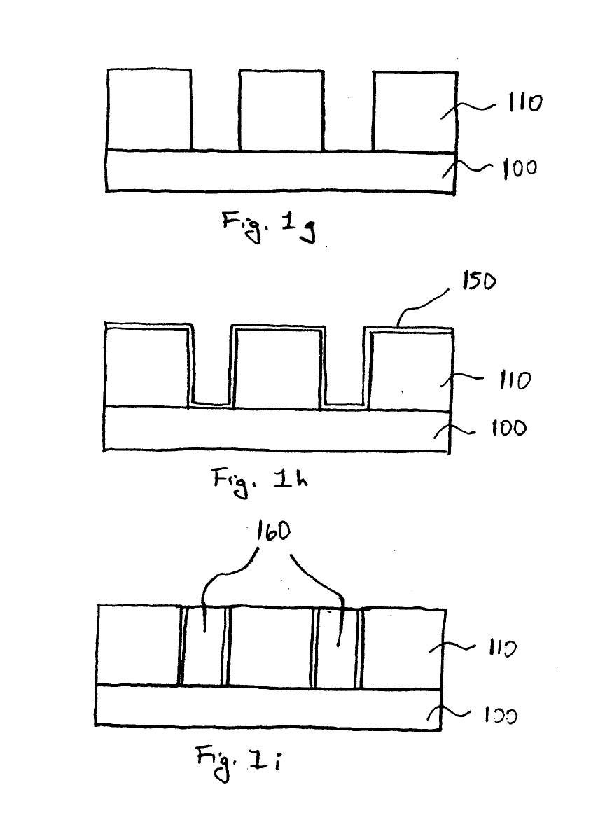

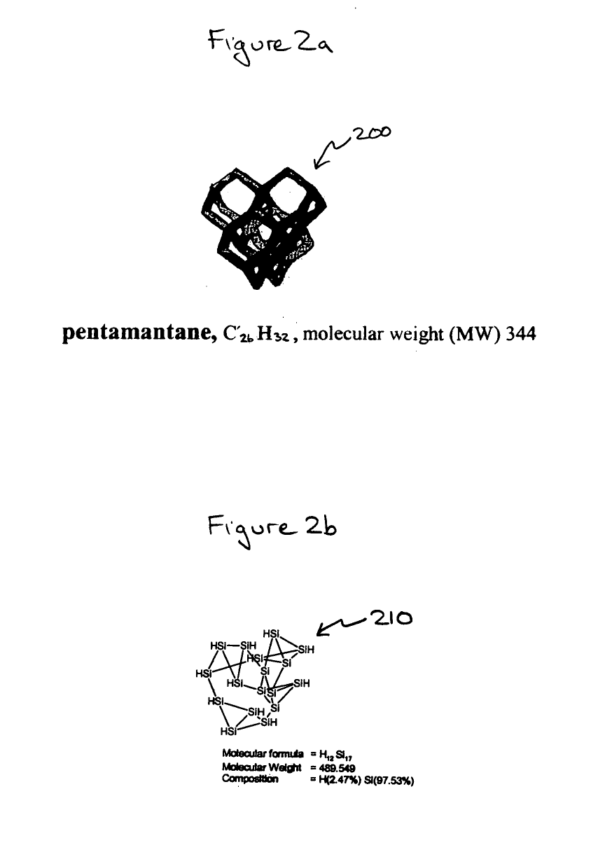

In FIG. 1a, substrate 100 is provided. Substrate 100 may be any surface generated when making an integrated circuit upon which a conductive layer may be formed. In this particular embodiment the substrate 100 may be a semiconductor such as silicon, germanium, gallium arsenide, silicon-on-insulator or silicon on sapphire. A dielectric layer 110 is formed on top of substrate 100. Dielectric layer 110 may be an inorganic material such as silicon dioxide or carbon doped oxide (CDO) or a polymeric low dielectric constant material such as poly(norbornene) such as those sold under the tradename UNITY™, distributed by Promerus, LLC; polyarylene-based dielectrics such as those sold under the tradenames “SiLK™” and “GX-3™”, distributed by Dow Chemical Corporation and Honeywell Corporation, respectively; and poly(aryl ether)-based materials such as that sold under the tradename “FLARE™”, distributed by Honeywell Corporation. The dielectric layer 110 may have a thickness in the approximate range of 2,000 and 20,000 angstroms.

In FIG. 1b, after forming the dielectric layer 110, a bottom anti-reflective coating (BARC) 115 may be formed over the dielectric layer 110. In embodiments where non-light or EUV lithography irradiation is used, a BARC 115 may not be necessary. The BARC 115 is formed from an anti-reflective material that includes a radiation absorbing additive, typically in the form of a dye. The BARC 115 may serve to minimize or eliminate any coherent light from re-entering the photoresist 120, that is formed over the BARC 115 in FIG. 1c, during irradiation and patterning of the photoresist 120. The BARC 115 may be formed of a base material and an absorbant dye or pigment. In one embodiment, the base material may be an organic material, such as a polymer, capable of being patterned by etching or by irradiation and developing, like a photoresist. In another embodiment, the BARC 115 base material may be an inorganic material such as silicon dioxide, silicon nitride, and silicon oxynitride. The dye may be an organic or inorganic dye that absorbs light that is used during the exposure step of the photolithographic process.

In FIG. 1c a photoresist 120 containing ultraviolet light transparent nanoparticles is formed over the BARC 115. The photoresist 120 may be positive tone or negative tone. In a positive tone photoresist the area exposed to the radiation will define the area where the photoresist will be removed. In a negative tone photoresist the area that is not exposed to the radiation will define the area where the photoresist will be removed. The photoresist 120, in this particular embodiment, is a positive resist. The photoresist 120 may have a thickness sufficient to serve as a mask during an etching or implantation step. For example, the photoresist may have a thickness in the approximate range of 10 nm and 200 nm, and more particularly in the approximate range of 20 nm and 100 nm. In general, for implant purposes the photoresist will be thickest, for contact patterning the photoresist will be thinner than for implant purposes, and the photoresist will be thinnest for gate patterning.

The ultraviolet light transparent nanoparticles are added to the photoresist 120 to evenly expose the photoresist to ultraviolet light throughout the entire thickness of the photoresist. The ultraviolet light transparent nanoparticles may be transparent to all ultraviolet wavelengths of light including deep ultraviolet (DUV) light and extreme ultraviolet light EUV. Ultraviolet light wavelengths of particular important in the DUV range includes 248 nm. In the EUV range, the ultraviolet light transparent nanoparticles are transparent to light at the wavelength of 13.5 nm. Other particular wavelengths of ultraviolet light that are used to irradiate photoresists include 193 nm and 157 nm.

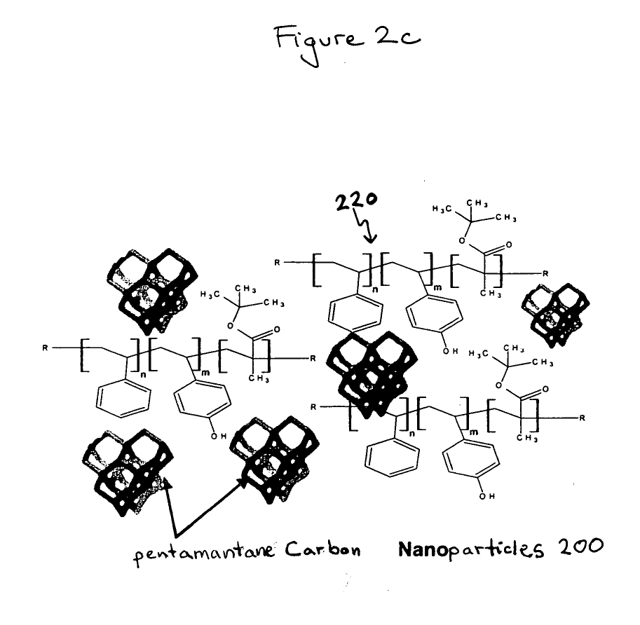

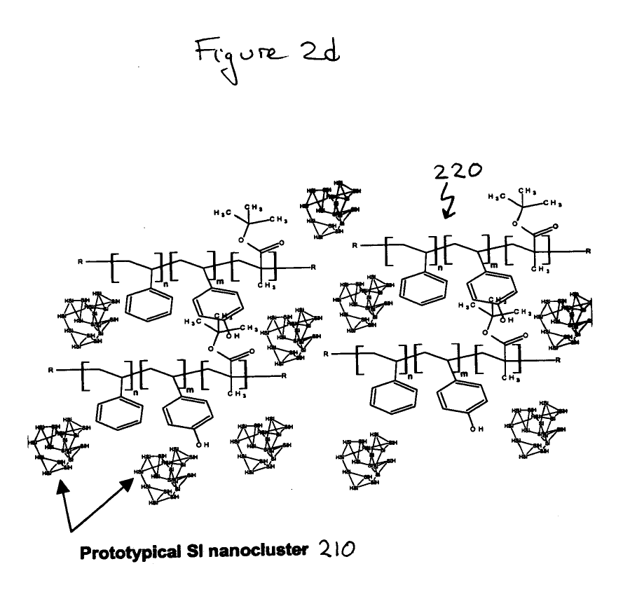

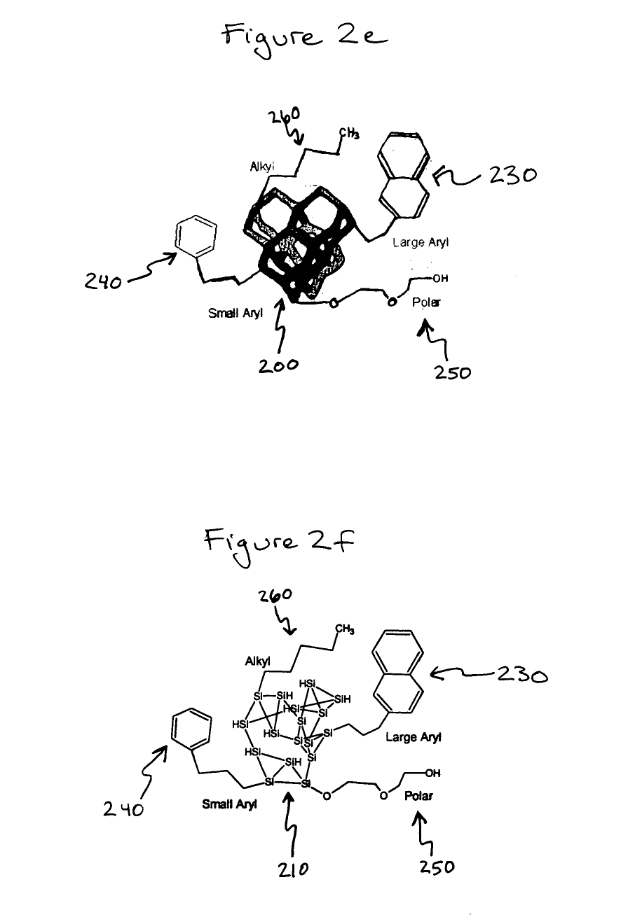

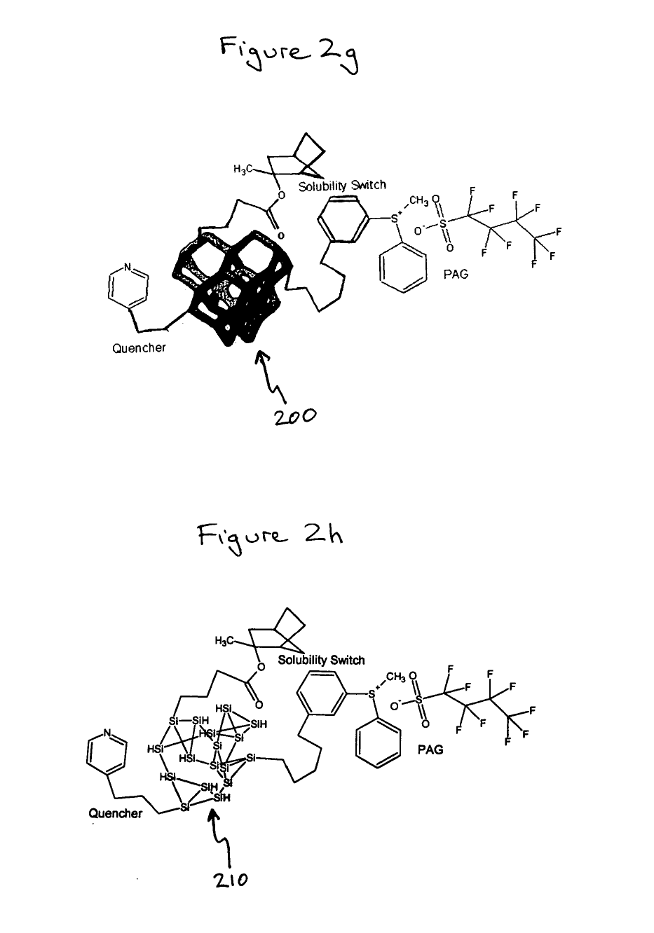

The ultraviolet light transparent nanoparticles may be any ultraviolet light transparent particle that is smaller than approximately 100 nm as the largest dimension. The ultraviolet light transparent nanoparticles may be carbon nanoparticles or silicon nanoparticles. Both carbon and silicon are transparent to ultraviolet light in all ranges and therefore will be transparent to the ultraviolet light as it enters the photoresist. The carbon nanoparticles may be adamantane oligomers such as the pentamantane nanoparticles 200 illustrated in FIG. 2a, amorphous carbon nanoparticles, or clusters of carbon atoms. The adamantane oligomers may be between 2 and 7 monomers of individual adamantane molecules fused together. Of particular value are adamantane oligomers having tetrahedral geometry and lattice spacing similar to that of diamond. In particular, the adamantane oligomers may be tetramantane that is 4 adamantane molecules fused together. Tetramantane is valuable because it forms a true diamond-like lattice. A diamond-like lattice is valuable because it is a very compressed and regular structure and therefore minimizes and regularizes the scattering of ultraviolet light. The diamond-like lattice is also valuable because it is a very stable structure and is therefore very etch-resistant. The adamantane oligomers are commercially and economically available as a purified waste product from crude oil. The carbon nanoparticles may also be norborane oligomers. Norborane contains fewer carbon atoms than adamantane and will have tighter angles between the carbon atoms than the diamond-like adamantane oligomers. The amorphous carbon nanoparticles may be nanotubes or multiwalled nanotubes such as onions and horns, purified asphalt, purified carbon black, or purified soot. The clusters of carbon atoms are aggregates of approximately 25 carbon atoms or less. The carbon nanoparticles may include a small amount of hydrogen. For example, pentamantane 200 illustrated in FIG. 2a has a chemical formula of C₂₆H₃₂.

The silicon nanoparticles may be more than 25 silicon atoms and have a largest dimension of approximately 100 nm or less. The silicon nanoparticles may also be clusters of silicon atoms that are aggregates of approximately 25 silicon atoms or less. A silicon nanocluster 210 is illustrated in FIG. 2b. The silicon nanoparticles, such as 210, may include a small amount of hydrogen. FIG. 2b illustrates a silicon nanocluster having a formula of H₁₂Si₁₇, where the hydrogen is approximately 2.47% of the silicon nanocluster and the silicon is approximately 97.53% of the nanocluster. Silicon nanoparticles may be formed by treating a silicon wafer with hydrogen fluoride (HF) to form an amorphous surface having a large surface area and subsequently sonicating the silicon wafer to release silicon nanoparticles. The size of the nanoparticles released may be controlled through reaction conditions. Both the carbon and silicon nanoparticles are free of any atoms that absorb EUV light, such as oxygen and fluorine. Carbon nanoparticles formed with only single covalent bonds between constituent atoms (for example, the diamondoids tetramantane and pentamantane) are transparent not only to EUV light, but many other lower energy light including 248 nm, 193 nm, and 157 nm. Pure carbon or silicon nanoparticles are therefore valuable in UV optical materials. The ultraviolet light transparent nanoparticles may also be formed of combinations of ultraviolet light transparent atoms, such as carbon and silicon (e.g. silicon carbide nanoparticles.)

The photoresist 120 according to embodiments of the present invention may have one of three general types of photoresist formulation. In one embodiment, the photoresist 120 may be a standard photoresist formed of polymers and small particles to which ultraviolet light transparent nanoparticles are homogeneously dispersed as a “filler” to dilute the ultraviolet light absorbing (opaque) atoms such as oxygen and fluorine (and to a lesser extent, nitrogen and sulfur). In this embodiment, the ultraviolet light transparent nanoparticles that are added to the photoresist formulations may be added as discreet compounds or bound to side-chains of the photoimageable species within the photoresist 120. In another embodiment, the photoresist 120 formulation may contain the ultraviolet light transparent nanoparticles as the photoimageable species, where each particle displays surface functionality required for all aspects of the photochemistry of a photoresist (e.g. PAG, quencher and solubility switch). In another embodiment, the photoresist 120 formulation may comprise a blend of discretely functionalized nanoparticles displaying one of a PAG, a quencher or a solubility switch moiety, individually or as combinations. In another embodiment, the photoresist 120 formulation may be a hybrid of the formulations just described, where the ultraviolet light transparent nanoparticles are functionalized but are also added as filler material in the photoresist matrix. In this embodiment, the photoresist 120 formulation may comprise a blend of unfunctionalized ultraviolet light transparent nanoparticles and discretely functionalized ultraviolet light transparent nanoparticles that have one of a PAG, a quencher or a solubility switch moiety individually or any combination of a PAG, a quencher, and a solubility switch. The photoresist 120 may also be blended with small molecules (e.g. PAGs and/or quenchers and/or other additives) and/or large molecules (polymers with functionality comprising PAGs, quenchers, and/or solubility switches).

FIGS. 2c and 2d illustrate the embodiment where the ultraviolet light transparent nanoparticles are added as “filler” to a standard photoresist formulation. FIG. 2c illustrates a photoresist 120 containing parahydroxystyrene-based co-polymer 220 as the photoimageable species and pentamantane nanoparticles 200 that have been added to the photoresist 120 formulation as discreet compounds. FIG. 2c illustrates a photoresist 120 containing a parahydroxystyrene-based co-polymer 220 as the photoimageable species and silicon nanoclusters 210 as discreet compounds. In an alternate embodiment, the ultraviolet light transparent nanoparticles may be any of those described above, either individually or in combination. The amount of the ultraviolet light transparent nanoparticles that are added to the photoresist formulation may be an amount to “fill” approximately 10 weight percent and 70 weight percent, dry weight. In one particular embodiment, the largest dimension of the ultraviolet light transparent nanoparticles may be less than approximately 5 nm and more particularly less than approximately 2 nm. The size distribution of the nanoparticles within the photoresist 120 may be approximately 2 nm plus or minus 1 nm, and more particularly 1 nm plus or minus approximately 0.1 nm to 0.3 nm. In yet another alternate embodiment, the ultraviolet light transparent nanoparticles may be added as side-chains to the photoimageable species, such as the parahydroxystyrene-based co-polymer 220.

The photoimageable species in the photoresist 120 may also be polymers, oligomers (i.e. a species with a molecular weight less than 3000 daltons), or small-molecules (i.e. species with a molecular weight less than 1000 daltons). Polymers that may be used as the photoimageable species may be monomers of for example, t-butylcarboxylate protected parahydroxystyrene (TBOC-PHST), methacrylate, acrylate, as well as an environmentally stable chemically amplified photoresist (ESCAP), and cycloolefin addition polymers. Additionally, the oligomers, hyperbranched, and dendritic materials based on these polymers may be used. Small molecule resist species that may be used include, for example, materials derived from steroids and calyxiranes. These photoimageable species may be used in photoresists imaged by 193 nm, 157 nm, deep ultraviolet (DUV), extreme ultraviolet (EUV), electron beam projection, and ion beam lithographic technologies. The photoimageable species may be present in the photoresist 120 in an amount in the approximate range of 80% to 90% by dry weight.

As described above, the ultraviolet light transparent nanoparticles may be added to this photoresist formulation as discreet particles within the photoresist 120 matrix, or as side-chains on the photoimageable species. In either embodiment, the ultraviolet light transparent nanoparticles may be functionalized with functional groups by well known processes for both carbon and silicon nanoparticles. These functional groups may enable the nanoparticles compatibility with the lithographic material matrix. The nanoparticles may be functionalized with functional groups such as straight or branched chains or chains with rings, polyethylene glycol (PEG) or polypropylene glycol (PPG) to better solvate the ultraviolet light transparent nanoparticles in standard photoresists. Functional groups on the ultraviolet light transparent nanoparticles may also enable the engineering of the glass transition temperature (Tg) of the photoresist 120. The glass transition temperature is the temperature where the photoresist begins to soften. In general, the glass transition temperature of the photoresist should be high enough to prevent distortion of the photoresist so that it maintains sharp edges when patterned but low enough that the photoresist is not brittle or too rough. Another property that may be engineered by adding functional groups to the ultraviolet light transparent nanoparticles is etch resistance. Functional groups that increase etch resistance of the photoresist 120 include aryl groups and steroidal or alicyclic cages. Functional groups may also be added to the ultraviolet light transparent nanoparticles to increase the spatial distribution of the nanoparticles, the coating properties of the photoresist, and the adhesion of the photoresist to the substrate on which it is placed. For all of these properties within a photoresist that is formed mainly of polar components, polar functional groups such as alcohols, thiols, lactones, carboxylic acids, and polyethyleneglycol may be added to the ultraviolet light transparent nanoparticles. In a mainly non-polar photoresist, non-polar functional groups such as hydrocarbon moiety derivatives may be used. With all of these functional groups it is valuable to minimize the elements that absorb ultraviolet light such as oxygen, sulfur, and fluorine.

Examples of ultraviolet light absorbing nanoparticles that have been functionalized are illustrated in FIGS. 2e and 2f. FIG. 2f illustrates a carbon nanoparticle, pentamantane nanoparticles 200, to which a large aryl group 230 and a small aryl group 240 have been added to increase etch resistance, a polar group 250 has been added to increase the spatial distribution of the nanoparticles, the coating properties of the photoresist, and the adhesion of the photoresist to the substrate on which it is placed. The polar group 250 has also been added to ensure that the nanoparticle may be dispersed in developer. An alkyl group 260 has also been added to enable the nanoparticles compatibility with the lithographic material matrix. The analogous compound with a silicon nanocluster 210 is illustrated in FIG. 2f.

The photoresist 120 of this embodiment also includes a photoacid generator (PAG). Suitable PAGs may include, for example, a loading of from 0.5% to 10% dry weight of triphenysulfonium nonaflurobutanesulfonate, bis(t-butylphenyl)iodonium nonafluorobutane sulfonate and diphenylmethyl nonaflurobutane sulfonate.

The photoresist 120 of this embodiment also includes a quencher. The quencher serves to buffer the photoacid generated by irradiation of the PAG. Any base may be used as the quencher, and the amount of quencher varies in relation to how much control of the photoacid is desired. The quencher may be present in an amount in the approximate range of 0.1% and 5% of the photoresist 120 by dry weight, and more particularly in the approximate range of 0.5% and 2% of the photoresist 120 by dry weight. Examples of quenchers include tetrabutylammonium hydroxide, collidine, analine, and dimethylaminopyridine.

The additives in the photoresist 120 may be any one of or a combination of a plasticiser, a surfactant, an adhesion promoter, an acid amplifier, a dissolution inhibitor or a dissolution promoter. The additives are present in an amount that is the balance of the % dry weight of the components of the photoresist. In one particular example, the plasticiser may be a cholate type plasticiser present in an amount in the approximate range of 0.1% and 2.0% dry weight. The components of the photoresist are mixed with a solvent. The solvent may be, for example, polypropylene glycol monomethyl ether acetate (PGMEA), ethyl lactate, cyclohexanone, heptanone, gammabutylolactone or cyclopentanone. The choice of solvent depends on the polarity of the components used to form the photoresist. The amount of solvent is dependent on the thickness of the photoresist and on the size of the wafer. If a thicker photoresist 120 is desired then less solvent is used, and if a thinner photoresist 120 is desired more solvent is used. Also, for larger wafers, more solvent is used, (e.g., a lower viscosity formulation is required). In a particular embodiment, for the photoresist 120 used for 248 nm, 193 nm, and EUV (in particular 13.5 nm) the amount of solvent used may be in the approximate range of 99% to 90% by weight of the diluted photoresist 120.

In the second embodiment, the photoresist 120 may be formed of an ultraviolet light transparent nanoparticle that serves as the photoimageable species. In this embodiment, the photoimageable species formed of the ultraviolet light transparent nanoparticles may be one discreet component of the photoresist 120 and mixed with the other photoresist 120 components including the quencher, the photoacid generator, and various additives in a solvent. Alternatively, the ultraviolet light transparent nanoparticles may be the core building block to which the other main components of the photoresist are functionalized.

In the embodiment where the ultraviolet light transparent nanoparticles are functionalized with the other main components of the photoresist, the ultraviolet light transparent nanoparticles may each be functionalized with a solubility switch, a photoacid generator, and a quencher in a deliberately engineered arrangement to optimize the performance of the photoresist. The performance and patterning quality of photoresists may be improved by placing the components of the photoresist in a deliberately engineered arrangement with respect to one another within individual photoresist units, or pixels. A photoresist formed of pixels, a “pixelated” photoresist, ensures that the components of the photoresist are uniformly distributed throughout the resist. Also, by forming the photoresist of specifically engineered pixels, each of the pixels containing the active components of the photoresist is of controlled size and symmetry. The control of the distribution of the components and the uniformity of the size and symmetry of the pixels may serve to optimize the performance of the photoresist. Furthermore, the components within each of the pixels may be arranged to optimize photospeed and to minimize diffusion of the photoacid once it is activated.

The main components of a photoresist are a photoacid generator (PAG), a photoimageable species such as the ultraviolet light absorbing nanoparticle, a solubility switch to change the solubility of the photoimageable species when activated by the photo-generated acid produced by the photoacid generator, and a quencher to control the activity of the photo-generated acid. The deliberately engineered arrangement of the components places the PAG in close proximity to the switches on the photoimageable species and separates the quencher from the PAG by the photoimageable species. This arrangement ensures that the photospeed of the photoresist is maximized by positioning the PAG in close proximity to the switch on the photoimageable species and by ensuring that the quencher cannot come between the PAG and the switch to reduce the activity of the photogenerated acid before it can react with the switch. This arrangement also ensures that the photogenerated acid does not react with switches on photoimageable species that are beyond the region that has been addressed by radiation. This occurs by surrounding the engineered ensemble of the PAG, switch, and photoimageable species by quencher. Once the photogenerated acid reacts with the switch and deprotects the photoimageable species to thereby change the solubility of the photoimageable species, the photogenerated acid may be neutralized by the basic quencher positioned beyond the photoimageable species.

In an embodiment, the ultraviolet light transparent nanoparticles as the core of the pixilated photoresist may be further functionalized to self-assemble onto a substrate surface. The functional group that would bind to the substrate may be tailored to bind to different types of substrates, such as semiconductors or dielectric materials. For example, SiOH groups displayed on silicon dioxide substrate surfaces (either thermal oxide grown on Si or native oxide formed on Si held in moist air) may be treated with ultraviolet light transparent nanoparticles displaying moieties combining a substrate binding species and a photochemical switch, where the photochemical switch may be a tertiary ester group bound to a triethoxysilyl moiety. This may form a covalent bond between the nanoparticle and the surface. The covalent bond can undergo scission to release the particle upon the action of the photo-generated acid resulting from exposure of photoacid generator to ultraviolet light. Examples of substrate binding groups include triethoxysilyl (to bind to SiOH surfaces), olefin (to bind to SiH surfaces), thiol (to bind to Au and Cu surfaces), and phosphate (to bind to TiO₂ surfaces). This self-assembling photoresist may allow precise control of the placement of pixels of the photoresist and may therefore be valuable in improving contrast of the photoresist.

Examples of ultraviolet light transparent nanoparticles that have been functionalized with a solubility switch, a photoacid generator, and a quencher to form pixels within the photoresist 120 are illustrated in FIGS. 2g and 2h. FIG. 2g illustrates a carbon nanoparticle, pentamantane 200, as the photoimageable species that is the core of a photoresist pixel. FIG. 2h illustrates a silicon nanocluster 210 as the photoimageable species that is the core of the photoresist pixel. The solubility switch may be a tertiary ester, an ether or an acetal. The quencher and the photoacid generator that are bound to the ultraviolet light transparent nanoparticles may be any of those described above attached by a side-chain. In these embodiments the ultraviolet light transparent nanoparticles may be further functionalized with side-groups to engineer different properties of the photoresist. The properties may include the glass transition temperature, etch resistance, spatial distribution of the nanoparticles within the photoresist 120, coating properties, and adhesion. The same functional groups as described above may be used to engineer these properties. Functional groups to make the ultraviolet light transparent nanoparticles compatible with one another may also be added. These functional groups may be any side-chain functionalized to the ultraviolet light transparent nanoparticles that increases the solubility of the nanoparticles in a solvent. Another side-group that may be added to the ultraviolet light transparent nanoparticles is a functional group the enables solubility change of the photoresist after irradiation of the photoresist. These types of functional groups are also known as “switches” because they switch the solubility of the photoresist. The switches may be photo-acid catalyzed switches or base-catalyzed switches. Base catalyzed switches include acetal functional groups with beta-hydrogens such as THP (tetrahydropyranyl) ether, an example of an acetal protecting group, tertiary carbonates with a beta hydrogen, such as t-butoxy carbonate (t-BOC), tertiary ethers with beta hydrogens such as t-butyl ethers, or tertiary esters with beta-hydrogens such as t-butyl esters.

In one specific embodiment, the photoresist 120 formulation contains tetramantane ultraviolet light transparent nanoparticles as discreet compounds mixed into a standard resist. The amount of tetramantane mixed into the photoresist formulation may be in the approximate range of 10 and 70 percent by dry weight, and more particularly in the approximate range of 30 and 50 percent by dry weight. The formulation further includes photoimageable species, for example, t-butylcarboxylate protected parahydroxystyrene (TBOC-PHST) monomers, methacrylate, acrylate, as well as an environmentally stable chemically amplified photoresist (ESCAP), and cycloolefin addition polymers. Additionally, the oligomers, hyperbranched, and dendritic materials based on these polymers may be used. Small molecule photoresist species that may be used as the photoimageable species include, for example, materials derived from steroids and calyxiranes. The amount of photoimageable species may be in the approximate range of 80% and 97% by dry weight. The formulation also includes a photoacid generator, such as triphenylsulfonium nonafluorobutane sulfonate, bis (t-butylphenyl)iodonium nonafluorobutane sulfonate and diphenylmethyl nonafluorobutane sulfonate at a loading of approximately 0.5% to 10% dry weight. The formulation may also include a quencher such as the bases tetrabutylammonium hydroxide, collidine, analine, and dimethylaminopyridine. The amount of quencher may be in the approximate range of 0.1% and 5% by dry weight, and more particularly in the approximate range of 0.5% and 2% by dry weight. The formulation may further include a cholate-type plasticiser additive in the amount of approximately 0.1% and 2% by dry weight. The components of this photoresist formulation are dissolved in a solvent such as tetrabutylammonium hydroxide, the solvent added in an amount sufficient for a thickness in the approximate range of 1000 angstroms and 2500 angstroms and to cover a 300 mm wafer. The amount of solvent used may in the approximate range of 99% to 90% by weight of the diluted photoresist.

As illustrated in FIG. 1d, the photoresist 120 is placed in proximity to the mask 130. In the space between the photoresist 120 and the mask 130 there may be optics such as lenses and/or mirrors (not shown). In FIG. 1e, the photoresist 120 and the BARC 115 are patterned by exposing the masked layer to irradiation. The irradiation may be 193 nm, 157 nm, deep ultraviolet (DUV), extreme ultraviolet (EUV), electron beam projection, or ion beam lithographic technologies. In one particular embodiment, the irradiation used to pattern the photoresist 120 may be EUV having a wavelength of 13.5 nm. Upon irradiation, the antenna group of the PAG will receive the radiation and the energy from the radiation will cause the dissociation of the PAG and the production of a photo-generated acid (PGA). The photo-generated acid (PGA) may serve as a catalyst to deprotect and to change the solubility of the photoimageable species. The change in the solubility of the photoimageable species is to enable the solvation of the photoimageable species in a developer. In a negative photoresist the PGA will catalyze the cross-linking of the photoimageable species and the developer that is subsequently applied will remove the portions of the negative photoresist that were not cross-linked. A post-exposure bake may be performed on the photoresist 120 to enhance the mobility and therefore the diffusion of the PGA within the photoresist 120. The post-exposure bake may be performed at a temperature in the approximate range of 90° C. and 150° C. and for a time in the approximate range of 30 seconds and 90 seconds. The temperature and the time of the post-exposure bake are dependent on the chemistry of the photoresist 120. The developer may be applied after the post-exposure bake to remove the desired portions of the photoresist 120. The developer may be a basic aqueous solution.

The performance of the photoresist 120 may also be increased by adding etch-resistant groups to the ultraviolet light transparent nanoparticles and/or to the photoimageable species. The addition of etch resistant groups to the ultraviolet light transparent nanoparticles allows for the further modulation of the etch rate of the resulting photoresist 120, including better matching of the etch rate of the ultraviolet light transparent nanoparticles to the other components in the photoresist 120. By matching the etch rate of the ultraviolet light transparent nanoparticles to the other components of the photoresist 120 the etched portions of the photoresist 120 may have sharper resolution and less line roughness. The etch-resistant groups that may be used include alicyclic hydrocarbon-based functional groups (for example: norbornyl, ethylnorbornyloxy, adamantyl, dinorbornyl, cyclohexyl), steroidal groups, or aryl groups such as phenyl, naphthyl, anthracenyl, carbon nanotube and buckminsterfullerene (C60). The etch resistant groups may also be alkyl groups such as methyl, tertiary butyl, isopropyl, and hydrocarbon cages. The number of etch resistant groups is dependent on the etch rate of other components in the photoresist 120.

After the photoresist 120 is developed and removed, as illustrated in FIG. 1e, vias 140 are etched through dielectric layer 110 and through the BARC 115 down to substrate 100, as illustrated in FIG. 1f. Conventional process steps for etching through a dielectric layer may be used to etch the via, e.g., a conventional anisotropic dry oxide etch process. When silicon dioxide is used to form dielectric layer 110, the via may be etched using a medium density magnetically enhanced reactive ion etching system (“MERIE” system) using fluorocarbon chemistry. When a polymer is used to form dielectric layer 110, a forming gas chemistry, e.g., one including nitrogen and either hydrogen or oxygen, may be used to etch the polymer. After vias 140 are formed through dielectric layer 110, the photoresist 120 and the BARC 115 are removed as illustrated in FIG. 1g. Photoresist 120 and BARC 115 may be removed using a conventional ashing procedure.

A barrier layer 150 is then formed over the vias 140 and the dielectric layer 110 in FIG. 1h. The barrier layer 150 may comprise a refractory material, such as titanium nitride and may have a thickness in the approximate range of 100 and 500 angstroms. The barrier layer may be deposited by chemical vapor deposition (CVD), sputter deposition, or atomic layer deposition (ALD). The purpose of the barrier layer 150 is to prevent metals such as copper that expand at temperatures used in semiconductor processing from bleeding out of the vias and causing shorts. A metal layer 160 is then deposited into the vias 140. The metal layer may be copper, copper alloy, gold, or silver. In one particular embodiment copper is deposited to form the metal layer 160. Copper may be deposited by electroplating or electroless (catalytic) deposition that require first depositing a seed material in the vias 140. Suitable seed materials for the deposition of copper by electroplating or electroless deposition include copper and nickel. The barrier layer 150 may also serve as the seed layer.

FIG. 1i illustrates the structure that results after filling vias 140 with a conductive material. Although the embodiment illustrated in FIG. 1i illustrates only one dielectric layer 100 and vias 140, the process described above may be repeated to form additional conductive and insulating layers until the desired integrated circuit is produced.

Several embodiments of the invention have thus been described. However, those of ordinary skill in the art will recognize that the invention is not limited to the embodiments described, but can be practiced with modification and alteration within the scope and spirit of the appended claims that follow.

We claim:

1. A photoresist, comprising:
an ultraviolet light transparent nanoparticle;
a photoimageable species;
a first photoacid generator;
a first quencher; and
reaction products thereof.

2. The photoresist of claim 1, wherein the ultraviolet light transparent nanoparticle comprises a particle of less than approximately 100 nm at a largest dimension.

3. The photoresist of claim 1, wherein the ultraviolet light transparent nanoparticle comprises a carbon nanoparticle.

4. The photoresist of claim 3, wherein the carbon nanoparticle comprises an adamantane oligomer.

5. The photoresist of claim 4, wherein the adamantane oligomer comprises tetramantane.

6. The photoresist of claim 4, wherein the adamantane oligomer comprises pentamantane.

7. The photoresist of claim 3, wherein the carbon nanoparticle comprises an amorphous carbon nanoparticle.

8. The photoresist of claim 3, wherein the carbon nanoparticle comprises a cluster of carbon atoms.

9. The photoresist of claim 3, wherein the ultraviolet light transparent nanoparticle comprises a silicon nanoparticle.

10. The photoresist of claim 9, wherein the silicon nanoparticle comprises a silicon cluster.

11. The photoresist of claim 1, further comprising a substrate-binding species functionalized on the ultraviolet light transparent nanoparticle to bind the ultraviolet light transparent nanoparticle to a substrate.

12. The photoresist of claim 11, wherein the substrate-binding species comprises a compound that is capable of being decomposed by an acid to detach the ultraviolet light transparent nanoparticle from the substrate.

13. The photoresist of claim 1, wherein the ultraviolet light transparent nanoparticle further comprises a functional group to increase compatibility of the ultraviolet light transparent nanoparticle with the photoimageable species.

14. The photoresist of claim 1, wherein the ultraviolet light transparent nanoparticle comprises a side-chain on the photoimageable species.

15. The photoresist of claim 1, wherein the ultraviolet light transparent nanoparticle further comprises a solubility switch as a functional group.

16. The photoresist of claim 1, wherein the ultraviolet light transparent nanoparticle further comprises a second quencher as a functional group.

17. The photoresist of claim 1, wherein the ultraviolet light transparent nanoparticle further comprises a second photoacid generator as a functional group.

18. The photoresist of claim 1, wherein the ultraviolet light transparent nanoparticle further comprises a second solubility switch, a second quencher, and a second photoacid generator.

19. The photoresist of claim 14, wherein the ultraviolet light transparent nanoparticle further comprises a functional group to increase compatibility of the ultraviolet light transparent nanoparticle with the photoresist.

20. The photoresist of claim 14, wherein the ultraviolet light transparent nanoparticle further comprises a functional group to enable solubility change of the photoresist after irradiation.

21. A photoresist, comprising:
a photoimageable species comprising an ultraviolet light transparent nanoparticle, a photoacid generator, and a solubility switch;
a quencher; and
reaction products thereof.

22. The photoresist of claim 21, wherein the ultraviolet light transparent nanoparticle further comprises a substrate binding species.

23. The photoresist of claim 21, wherein the ultraviolet light transparent nanoparticle comprises a functional group to bind the ultraviolet light transparent nanoparticle to a substrate.

24. The photoresist of claim 21, wherein the photoimageable species further comprises the quencher.

25. The photoresist of claim 21, further comprising an ultraviolet light transparent nanoparticles functionalized with a functional group selected from the group consisting of a photoacid generator, a quencher, and a solubility switch.

26. A photoresist, comprising:
a first ultraviolet light transparent nanoparticle functionalized with a photoacid generator;
a second ultraviolet light transparent nanoparticle functionalized with a solubility switch; and
a third ultraviolet light transparent nanoparticle functionalized with a quencher.

27. The photoresist of claim 26, wherein the first ultraviolet light transparent nanoparticle, the second ultraviolet light transparent nanoparticle, and the third ultraviolet light transparent nanoparticle are each a same type of ultraviolet light transparent nanoparticles.

28. The photoresist of claim 26, wherein the first ultraviolet light transparent nanoparticle, the second ultraviolet light transparent nanoparticle, and the third ultraviolet light transparent nanoparticle are each a different type of ultraviolet light transparent nanoparticle.

29. A photoresist composition, comprising:
an environmentally stable chemically amplified photoresist;
a plurality of tetramantane nanoparticles;
a photoacid generator;
a quencher; and
reaction products thereof.

30. The photoresist composition of claim 29, wherein the plurality of tetramantane nanoparticles are discreet nanoparticles.

31. The photoresist composition of claim 29, wherein the plurality of tetramantane nanoparticles are bound to side-chains on the environmentally stable chemically amplified photoresist.

32. A method, comprising:
applying a photoresist to a substrate, the photoresist comprising an ultraviolet light transparent nanoparticle; and
patterning the photoresist by irradiating the photoresist with ultraviolet light.

33. The method of claim 32, wherein patterning the photoresist comprises irradiating the photoresist with ultraviolet light in the extreme ultraviolet range.

34. The method of claim 33, wherein irradiating the photoresist comprises irradiating the photoresist with light having a wavelength of approximately 13.5 nm.

35. The method of claim 32, wherein patterning the photoresist comprises irradiating the photoresist with ultraviolet light in the deep ultraviolet range.

36. The method of claim 32, wherein patterning the photoresist comprises irradiating the photoresist with ultraviolet light having a wavelength of approximately 193 nm.

37. The method of claim 32, wherein patterning the photoresist comprises irradiating the photoresist with ultraviolet light having a wavelength of approximately 157 nm.

38. The method of claim 32, wherein applying the photoresist to the substrate comprises applying a photoresist comprising tetramantane nanoparticles to the substrate.

39. The method of claim 32, wherein applying the photoresist to the substrate further comprises binding the photoresist to the substrate with surface-binding molecules.
